(19) United States
(12) Patent Application Publication
(10) Pub. No.: US 2011/0203950 A1
(43) Pub. Date: Aug. 25, 2011

(54) Disc book

(76) Inventor: George Yancosek, JR., Saco, ME (US)

(21) Appl. No.: 12/660,263

(22) Filed: Feb. 23, 2010

(51) Int. Cl. G11B 33/04

(52) U.S. Cl. 206/308.1

(57) ABSTRACT

The Disc Book is a book format for products that include a CD, DVD, vinyl LP, or any other type of disc. The Disc Book package incorporates within its design a booklet of 3 pages, which forms the stable exterior for additional pages to be attached within the booklet if desired. The product is designed for its ease of manufacture, infinitely adjustable size, and plastic-free construction. When the Disc Book is closed, the booklet is completely contained within the package. It is composed of heavyweight paper or card stock that can be printed on both sides through any traditional means.

### SPECIFICATION FOR THE DISC BOOK

There are no related applications.

There is no federally-sponsored research or development of this invention.

There are no supplemental materials.

### BACKGROUND OF THE INVENTION

The purpose of this invention is to provide a package which joins the pre-recorded and printed aspects of an artist or author's work. Containing a disc and companion materials, this design will be known as the “Disc Book.” It is a book format for products that include a CD, DVD, vinyl LP, or any other type of disc. The Disc Book package incorporates within its design a booklet of 3 pages, which forms the stable exterior for additional pages to be attached within the booklet if desired. It is composed of heavyweight paper or card stock that can be printed on both sides through any means. The product is designed for its ease of manufacture, infinitely adjustable size, and plastic-free construction.

It is differentiated from U.S. Pat. No. 3,426,960 (Shore) because the Disc Book has the structure for a booklet as part of the package. Additionally, the Disc Book allows for extension on the left side to create an additional panel which would provide a pocket for an additional disc and potentially additional booklet.

It is differentiated from U.S. Pat. No. 6,905,019 B2 (Lacomis) because the structure for the booklet is completely new; no comparison with design allowing for using the package as a magazine insert.

It is differentiated from U.S. Pat. No. 5,318,222 (Bartlett) because the Disc Book has the structure for a booklet as part of the package. The additional flap on Bartlett is strictly for mailer purposes and would not provide base for a booklet.

It is differentiated from U.S. Pat. No. 5,662,217 (Durr) because the Disc Book has the structure for a booklet as part of the package, and does not have a mechanism for closing the package as in Durr.

It is differentiated from U.S. Pat. No. 4,905,831 (Bagdis et al.) because the Disc Book has the structure for a booklet as part of the package. Further, the Disc Book does not have any detachable panels. The Disc Book does not have a mechanism for closing the package. The additional flap on Bagdis is strictly for mailer purposes and would not provide base for a booklet. Finally, Bagdis also allows for use of plastic disc holders, which would not be practicable on the Disc Book.

### BRIEF SUMMARY OF THE INVENTION

The Disc Book is a book format for products that include a CD, DVD, vinyl LP, or any other type of disc. The Disc Book package incorporates within its design a booklet of 3 pages, which forms the stable exterior for additional pages to be attached within the booklet if desired. In addition, the design utilizes an inside opening for the disc. It is composed of heavyweight paper or card stock that can be printed on both sides through any means. The product is designed for its ease of manufacture, infinitely adjustable size, and plastic-free construction.

### BRIEF DESCRIPTION OF THE DRAWINGS

The Disc Book package is a single sheet of printable material, with at least four segments of equal size, a Spine deep enough to accommodate the contents of the package, and two extending flaps of sufficient height to seal the disc opening.

FIG. 1 shows the outside view of the standard 4-panel Disc Book package.

FIG. 2 shows the inside view of the standard 4-panel Disc Book package.

FIG. 3 shows the variation of the package extended on the right side to create an accordion-style booklet by extending the package with additional panels.

FIG. 4 shows the variation of the package extended on the left side to create a second pocket which can accommodate a second disc. On all drawings, dotted lines indicate fold lines.

### DETAILED DESCRIPTION OF THE INVENTION

The Disc Book package is a multipurpose format for disc distribution which allows for any desired written or art materials to be included in the attached booklet and containment of the disc in the pocket. This format avoids exterior openings and loose storage of the booklet, thus preventing damage and loss that occur with other package designs. It is constructed from a single sheet of material, and comprised of four (or more) segments of equal size, as well as a Spine deep enough to accommodate the contents of the package, and two extending flaps of sufficient height to seal the disc opening. On all drawings, dotted lines indicate fold lines.

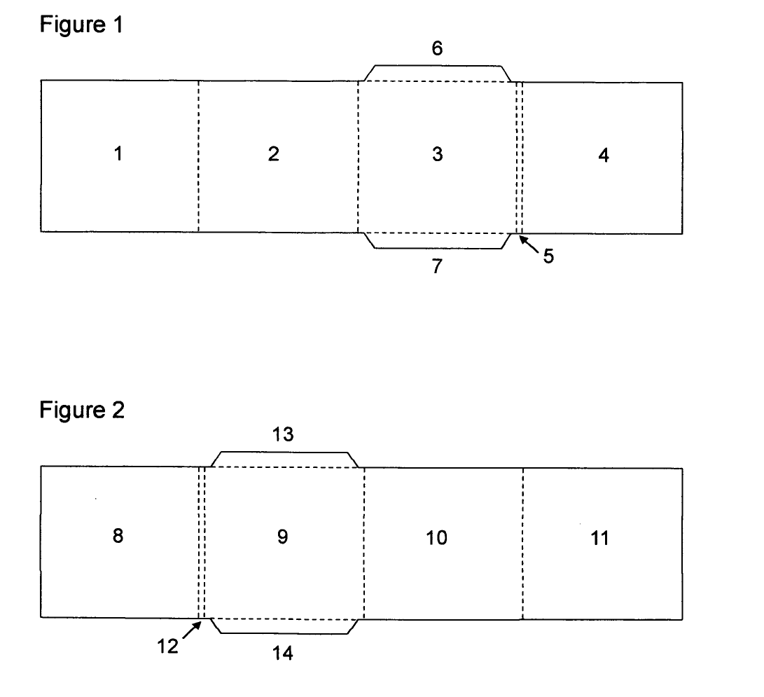

As seen in FIG. 1, panel 4 is the front cover of the Disc Book, 5 is the outside spine, panel 3 is the back of the Disc Book, panel 2 is the inside back of the booklet, and panel 1 is the inside front of the booklet. In FIG. 2, panel 8 is the inside front cover of the Disc Book, 12 is the inside spine, panel 9 is the bottom of the disc enclosure, panel 10 is attached by glue or other adhesive to tabs 6 and 7 to form the pocket for a disc, and panel 11 is the front of the booklet.

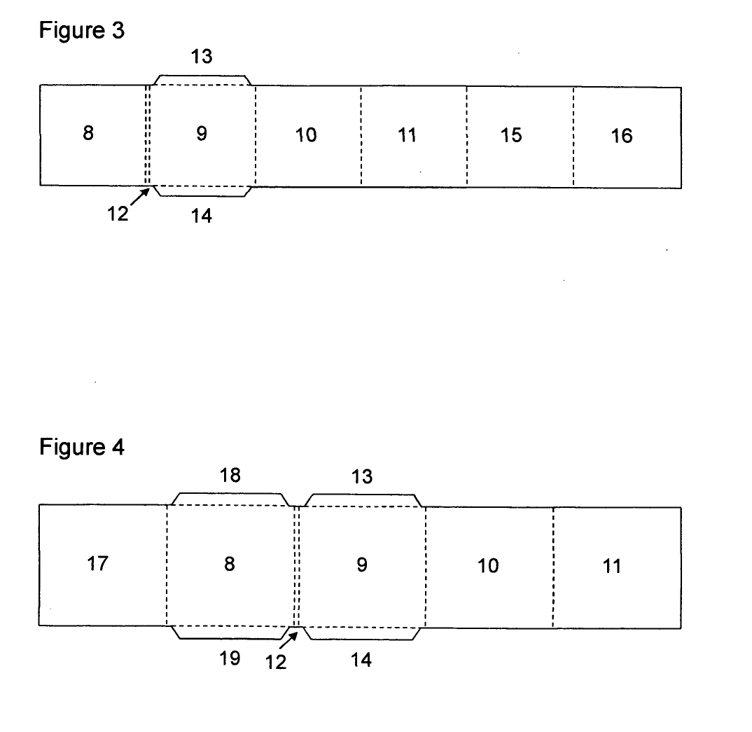

It is possible for the package to be extended on the right side to create an accordion-style booklet by extending the package with additional panels as exemplified by panels 15 and 16 in FIG. 3.

It is also possible to extend the package on the left side to accommodate a second disc. As seen in FIG. 4, by adding panel 17 and top and bottom flaps 18 and 19, a pocket will be created by folding panel 17 onto panel 8 and attaching it by glue or other adhesive to tabs 18 and 19.

The Disc Book package can be sized to accommodate any recorded material. It is possible to use this format, for example, with 33⅓ RPM vinyl LPs or 45 RPM singles. It is also possible to create a full-length book which includes a disc by utilizing the design with a wide spine. The same general principles of the design exist regardless of the actual dimensions.

Furthermore, it is possible to use this format while maintaining the same height or width as jewel case CDs and plastic box DVDs, thus allowing for continued use of storage and sale facilities while offering an improved package.

A final advantage to this product is that the package is constructed with no plastic, even using entirely recycled or recyclable paper products, allowing it to be marketed as a “green” or environmentally-friendly design.

This product is distinctly different from any other patented designs in one specific way:

1) The Disc Book package is formed from a single sheet of printable material that incorporates a booklet of 3 pages and creates a pocket inside the unit.

2) The same package construction may be resized for use with any size disc and any size booklet.

3) The Disc Book package incorporates a booklet of at least 3 pages as an inherent component of the disc package to join the pre-recorded and printed aspects of an artist or author's work, and may be resized for use with any size disc and any package dimensions.
